(19) United States
(12) Patent Application Publication
(10) Pub. No.: US 2012/0300057 A1
(43) Pub. Date: Nov. 29, 2012

(54) SELF-CONTAINED SIGNAL CARRIER FOR PLUMBING & METHODS OF USE THEREOF

(75) Inventor: John Bartucciotto, Orange, CA (US)

(73) Assignee: EPL SOLUTIONS, INC., Orange, CA (US)

(21) Appl. No.: 13/547,766

(22) Filed: Jul. 12, 2012

Related U.S. Application Data
(63) Continuation-in-part of application No. 13/425,313, filed on Mar. 20, 2012.
Application No. 13/425,313 is a continuation of application No. 12/480,625, filed on Jun. 8, 2009, now abandoned.
(60) Provisional application No. 61/059,282, filed on Jun. 6, 2008.

(51) Int. Cl. H04N 7/18; B08B 9/00

(52) U.S. Cl. 348/84; 15/104.33; 134/166 C; 348/E07.085

(57) ABSTRACT

A device is provided for remotely locating an obstruction in a plumbing system. The spring assembly may include (i) a connector having a sewer cable connection portion at a proximal end and a retaining collar portion at a distal end; (ii) a spring having a proximal end, a medial portion and a distal end, the proximal end of the spring connected to the distal end of the connector; (iii) an end cap connected to a distal end of the spring. A signal transmitter may be removably housed within the spring. A cable may be connected to the connector at the proximal end of the connector to push or drive the spring assembly through a pipe system. A receiver may be used to detect wireless signals from the signal transmitter, thereby determine a location of an obstruction in the pipe system.

### CLAIM OF PRIORITY

This non-provisional United States (U.S.) Patent Application is a continuation-in-part application of, and claims priority on, non-provisional U.S. patent application Ser. No. 13/425,313 entitled “Self-Contained Signal Carrier for Plumbing & Methods of Use Thereof”, filed on Mar. 3, 2012, the contents of which is hereby incorporated by reference, which is a continuation of, and claims priority on, non-provisional U.S. patent application Ser. No. 12/480,625 entitled “Self-Contained Signal Carrier for Plumbing & Methods of Use Thereof”, filed on Jun. 8, 2009, the contents of which is hereby incorporated by reference, which claims priority to U.S. Provisional Application No. 61/059,282 entitled “Self-Contained Signal Carrier for Plumbing & Methods of Use Thereof”, filed Jun. 6, 2008, and hereby expressly incorporated by reference herein.

### FIELD OF INVENTION

At least one feature pertains to a device to universally adapt a flexible auger for use in plumbing of varied sizes.

### BACKGROUND OF INVENTION

A “plumber's snake” is a flexible auger, or push rod, used to remove clogs in plumbing that cannot be loosened with a plunger. Generally, a flexible auger consists of a single length of spring wire wound into small, uniform-diameter, closely spaced coils. The distal end of the auger, i.e., the spring, generally includes space between the coils, while the proximal end is attached to a device with a hand crank or motor drive which rotates the wire as it moves down into the pipe. The auger is stiff enough to be pushed lengthwise into a drain duct yet resilient enough to follow the curves in the duct, e.g., a P-trap.

Flexible push rods can also be modified for use as a probe. For example, a flexible push rod can be adapted to incorporate a micro-camera which is used to visually inspect plumbing. Visual inspections can be useful to locate plumbing or to detect cracks in plumbing. However, such modified flexible push rods are costly. Additionally, because the micro-camera is subjected to a harsh environment, e.g., harsh plumbing sidewalls, “banging” around, the micro-camera can be vulnerable to breakage. Replacement of the micro-camera can be costly.

An alternative probe to locate plumbing or to precisely locate a blockage is the use of a self-contained signal transmitter, or “sonde.” Sondes are used to trace the path of non-metallic pipes and locate line blockages in clay, cast iron and other non-conductive structures. Generally, sondes are programmed with a single matched frequency that is detectable by a locating receiver with a matching frequency. In application, a sonde can be flushed down a piping system and later retrieved, attached to a string for retrieval, or attached to a push rod by threading the sonde to the push rod. Flushing with later retrieval risks permanent loss of the sonde as does using a string for retrieval. Threaded sondes can be lost due to excessive flex being applied to the push rod resulting in the sonde becoming detached.

Consequently, a device to use a sonde as a locator in plumbing systems without risk of loss is needed.

### SUMMARY OF THE INVENTION

A spring assembly, including: (i) a connector having a sewer cable connection portion at a proximal end and a retaining collar portion at a distal end; (ii) a spring having a proximal end, a medial portion and a distal end, the proximal end of the spring connected to the distal end of the connector; and (iii) a self-contained signal transmitter housed within the spring is herein disclosed. The connector may further include a threaded insert therein. The threaded insert of the connector may threadedly engage with the proximal end of the spring. The spring assembly may further include an end cap connected to the distal end of the spring. The end cap may threadedly engage with the distal end of the spring. The proximal end and the distal end may include tightly wound coils and the medial portion may include coils spaced a distance from one another. When torque or flex is applied to the spring assembly, the connector functions to prevent expansion of the tightly wound coils at the proximal end of the spring. The medial portion of the spring may provide flexibility. The spring assembly may further include a cable connected to the sewer cable connection portion of the connector. The cable may be adapted to thread through a plumbing system when torque is applied thereto. The plumbing system may include a series of pipes with a diameter between one and one-half inches and eight inches. The self-contained signal transmitter may be detectable by a frequency locator. The spring assembly may be stainless steel.

A device for remotely detecting a location in a plumbing system, including, a spring assembly wherein the spring assembly includes (i) a connector having a sewer cable connection portion at a proximal end and a retaining collar portion at a distal end; (ii) a spring having a proximal end, a medial portion and a distal end, the proximal end of the spring connected to the distal end of the connector; (iii) an end cap connected to a distal end of the spring; and (iv) a self-contained signal transmitter housed within the spring; a cable connected to the connector at a proximal end of the connector; and a frequency locator is herein disclosed. The cable may be adapted to thread through the plumbing system when torque is applied thereto. The plumbing system may be cast iron, PVC or clay. The plumbing system may include a series of pipes with a diameter between one and one-half inches and eight inches.

A method of assembly, including: (i) connecting a distal end of a connector having a sewer cable connection portion at a proximal end and a retaining collar portion at the distal end to a proximal end of a spring; (ii) inserting a self-contained signal transmitter within the spring; and (iii) connecting a proximal end of an end cap to a distal end of the spring is herein provided. The method may further include the step of connecting the sewer cable portion of the connector to a sewer cable. The method may further include the step of connecting the sewer cable to a frequency locator apparatus.

A device for locating an obstruction in a plumbing system is provided. The device includes a spring assembly comprising a nozzle having a nozzle proximal end integrally connected to a nozzle distal end via a nozzle medial portion, the nozzle medial portion includes a plurality of jets for receiving water under high pressure propelling the spring assembly down a pipe; and a first spring having a proximal end, a medial portion and a distal end, the proximal end of the spring connected to the nozzle distal end; and a camera assembly secured to the spring assembly via a clamp, the clamp threadedly engaged to the distal end of the first spring.

A device for locating an obstruction in a plumbing system is provided. The device includes a spring assembly. The spring assembly includes a nozzle having a nozzle proximal end integrally connected to a nozzle distal end via a nozzle medial portion, the nozzle medial portion includes a plurality of jets for receiving water under high pressure propelling the spring assembly down a pipe; and a first spring having a proximal end, a medial portion and a distal end, the proximal end of the spring connected to the nozzle distal end. The device further includes a camera assembly secured to the spring assembly via a clamp, the clamp threadedly engaged to the distal end of the first spring. The camera assembly includes an elongated rod; a second spring, having a second spring proximal end connected to a second spring distal end; and a spring connector integrally connecting the second spring proximal end to the elongated rod.

### BRIEF DESCRIPTION OF THE DRAWINGS

FIG. 1A illustrates a side view of a spring assembly according to an embodiment of the invention.

FIG. 1B illustrates a cross-sectional side view of the spring assembly of FIG. 1A.

FIG. 1C illustrates a side view of a connector wherein the dashed lines represent a lumen of the connector according to an embodiment of the invention.

FIG. 1D illustrates a cross-sectional side view of a connector threadedly engaged with a proximal end of a spring wherein a retaining collar is situated about the area of threaded engagement.

FIGS. 2A-2C illustrate side and front views of a connector as well as a threaded insert according to an embodiment of the invention.

FIGS. 3A-3B illustrate cross-sectional views of an assembled connector with a threaded insert therein according to embodiments of the invention.

FIGS. 4A-4G illustrate front views of various connectors according to embodiments of the invention.

FIGS. 5A-5C illustrate cross-sectional views of various connectors according to embodiments of the invention.

FIG. 6 illustrates an embodiment of an end cap according to an embodiment of the invention.

FIG. 7 illustrates a schematic of a sewer cable attached to a spring assembly being used as a locator in a P-trap according to an embodiment of the invention.

FIG. 8 illustrates a side view of a spring assembly according to an embodiment of the invention.

FIG. 9 illustrates a cross-sectional view of the nozzle in FIG. 8.

FIG. 10 illustrates a front elevational view of the nozzle in FIG. 8.

FIG. 11 illustrates a side view of the spring assembly of FIG. 8 having a camera assembly attached with a clamp.

FIG. 12A illustrates a top view of the clamp in FIG. 11.

FIG. 12B illustrates a front view of the clamp in FIG. 11.

FIG. 12C illustrates a front view of the clamp in FIG. 11.

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to spring assemblies adapted to house a self-contained signal transmitter, or sonde, without significant risk of loss. According to embodiments of the invention, a sonde can be housed within a spring assembly wherein the spring assembly is adapted to connect to a sewer cable. In one embodiment, a connector having a sewer cable connector portion and a retaining collar portion with a separate threaded insert therein attaches to a spring of the spring assembly. In another embodiment, a connector having a sewer cable connector portion attaches to the spring of the spring assembly and is locked in place by a separate retaining collar. According to embodiments of the invention, disengagement of the connector to the spring can be substantially or completely reduced as a result of the retaining collar portion of the connector or the separate retaining collar secured about the area in which the spring attaches to the connector.

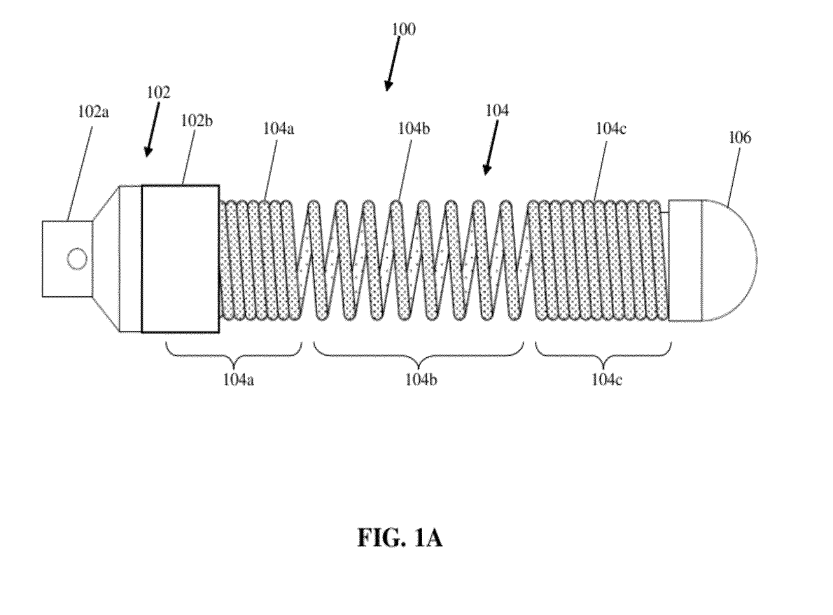

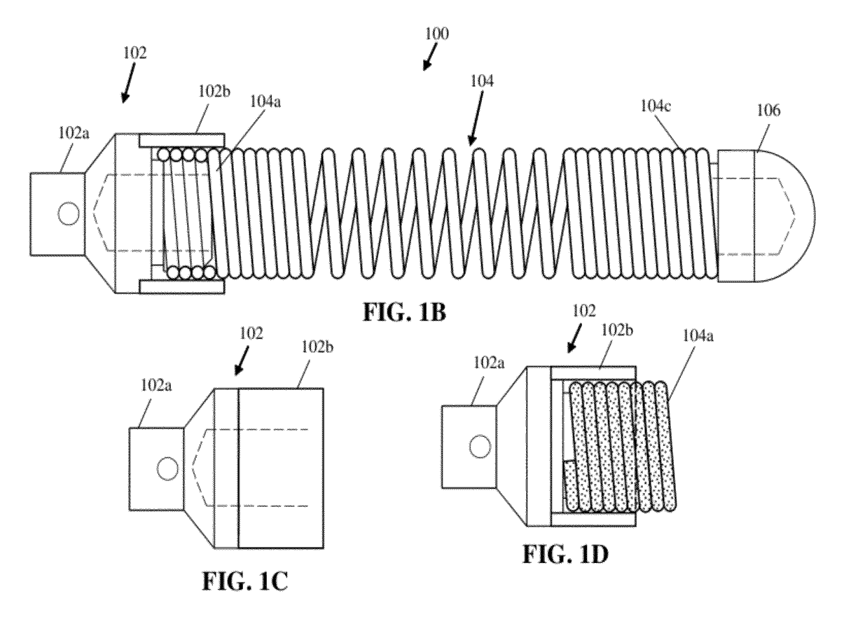

FIG. 1A illustrates a side view of a spring assembly according to an embodiment of the invention. A proximal end of the spring assembly 100 includes a connector 102 having a sewer cable connector portion 102a (proximal end thereto) and a retaining collar portion 102b (distal end thereto). Generally, the connector 102 attaches to a proximal end 104a of a spring 104. The spring 104 additionally includes a medial portion 104b and a distal end 104c. As shown, the proximal and distal ends 104a and 104c, respectively, of the spring 104 may be tightly wound coils, while the medial portion 104b of the spring 104 may be coils which are spaced a distance from one another or less tightly wound than the proximal and distal ends 104a and 104c. This feature provides flexibility to the spring 104. A distal end of the spring assembly 100 includes an end cap 106 attached to a distal end 104c of the spring 104.

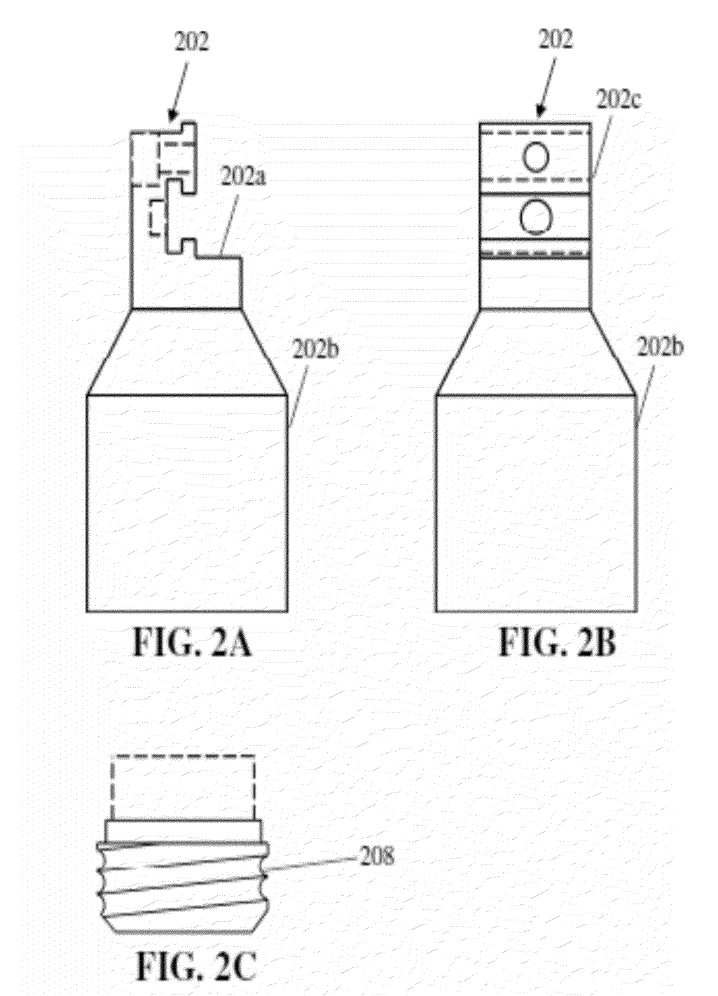

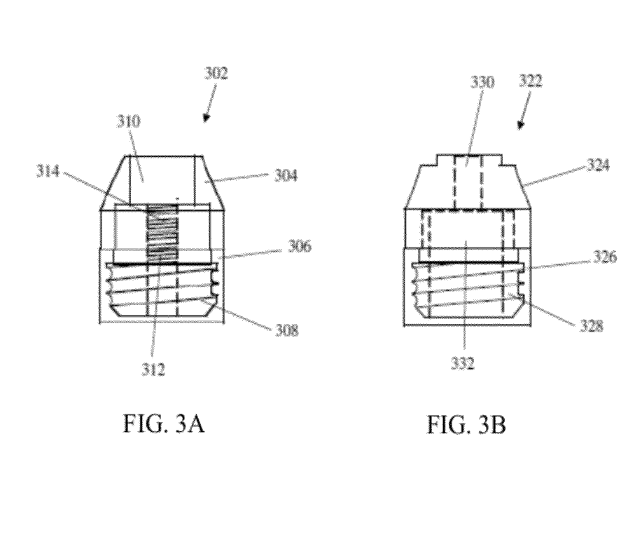

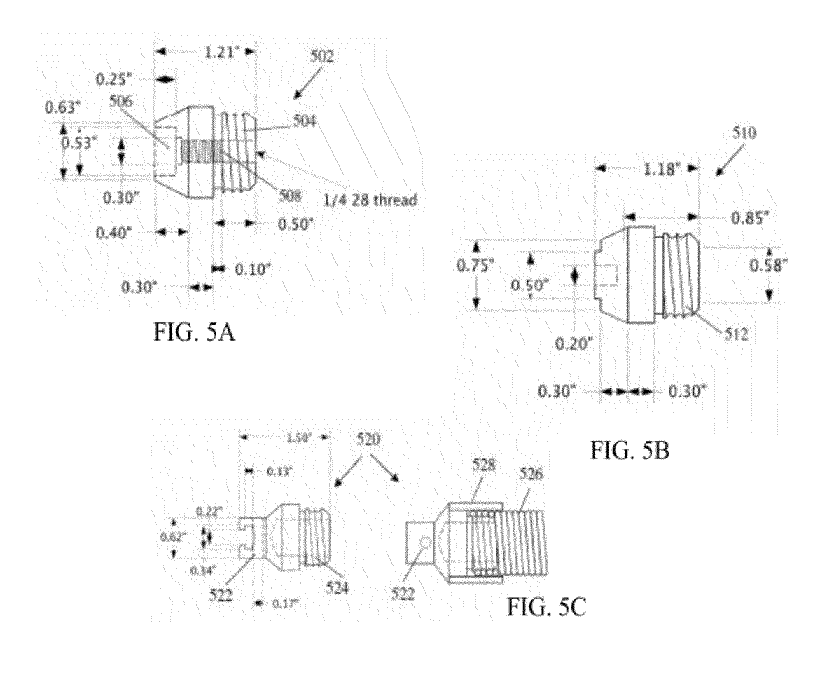

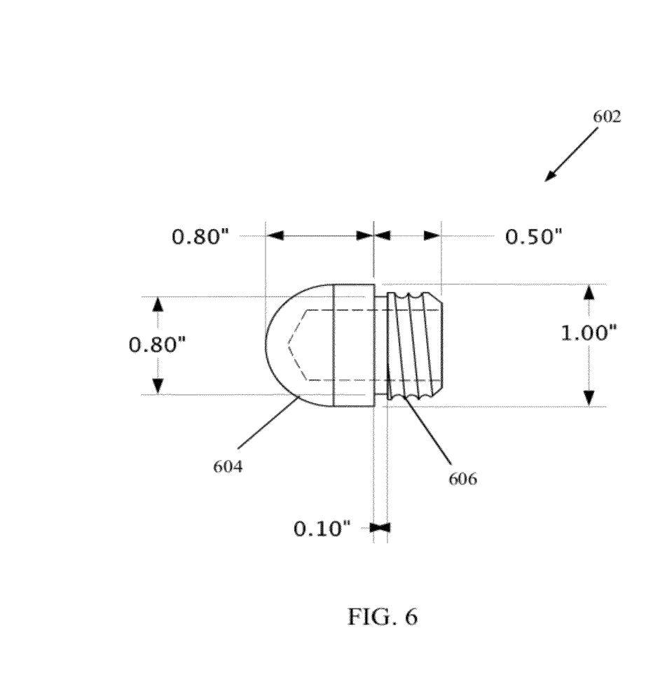

In one embodiment, a distal end of the connector 102 includes a threaded insert therein (see FIGS. 2A-2C) wherein the proximal end 104a of the spring 104 is adapted to receive the threaded insert (see FIGS. 1B and 1D). Thus, the connector 102 attaches to the spring 104 by threaded engagement of the threaded insert to a threaded portion within the proximal end 104a of the spring 104. In another embodiment, the connector 102 includes threads integral therein (see FIGS. 3A, 3B and 5A-5C) wherein the proximal end 104a of the spring 104 is adapted to directly receive the connector 102. A separate or integral retaining collar 102b may be crimped about the area of threaded engagement. Attachment of the separate retaining collar 102b may be done by various means, including welding, using screws, or threading onto the connector 102; however, other suitable means are within the scope of the invention. According to the embodiments described, the connector 102 is completely or substantially prevented from disengaging from the spring 104 as a result of the retaining collar portion 102b of the connector 102 or the separate retaining collar secured about the area in which the spring 104 attaches to the connector 102. More specifically, when torque or flex is applied to the spring assembly 100, the connector 102 substantially or completely prevents expansion of the tightly wound coils at the proximal end 104a of the spring 104. This, in turn, substantially or completely prevents the connector 102 from disengaging from the spring 104 when in use.

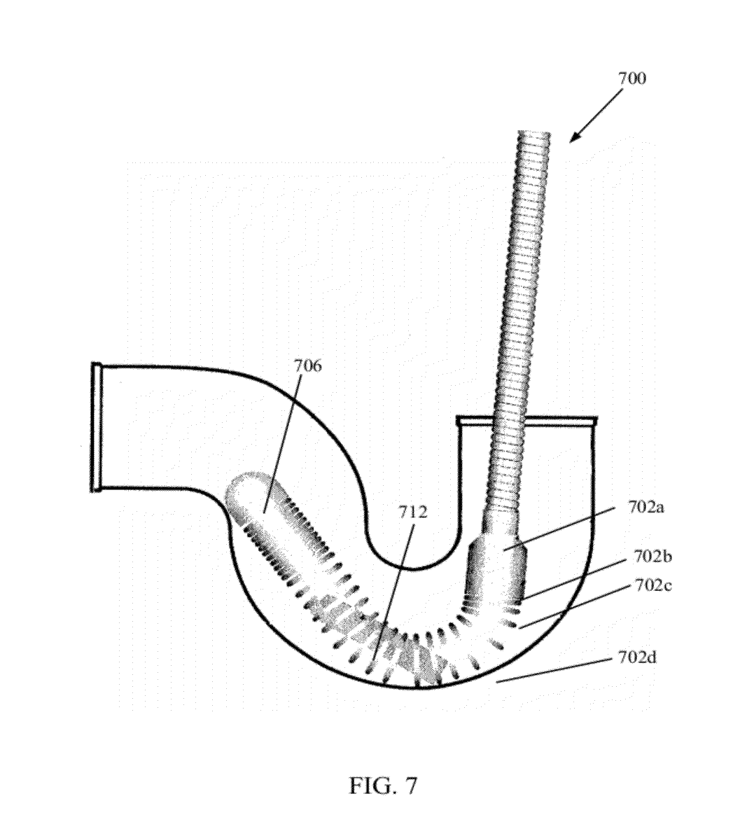

Similar to the connector 102, a proximal end of the end cap 106 may include threads therein (see FIG. 6) wherein the distal end 104c of the spring 104 is adapted to receive the threads. Thus, the end cap 106 attaches to the distal end 104c of the spring 104 by threaded engagement thereto. According to one embodiment, a sonde (not shown, see FIG. 7) can be housed within the spring assembly 100, more specifically, within the spring 104. The connector 102, the spring 104, and the end cap 106 may be manufactured using a suitable material, e.g., stainless steel.

FIG. 1B illustrates a cross-sectional side view of the spring assembly 100 of FIG. 1A. In this view, the threaded engagement of the distal end of connector 102, i.e., at retaining collar portion 102b, with the proximal end 104a of the spring 104 is more clearly shown. In an alternative embodiment, after threaded engagement thereof, a retaining collar portion is slipped over the spring assembly 100 and secured about the area of threaded engagement and then secured into place. In either embodiment, the retaining collar portion or retaining collar (whether separate or integral) makes it substantially or completely impossible for the spring 104 to disengage from the connector 102 when torque is applied thereto. As a result, the spring assembly 100 is permitted to spin and/or pass through plumbing of various sizes. Also shown in FIG. 1B are the medial portion 104b and the distal end 104c of the spring 104 as well as the end cap 108. FIG. 1C illustrates a side view of the connector 102 wherein the dashed lines represent a lumen of the connector 102. FIG. 1D illustrates a cross-sectional side view of the connector 102 threadedly engaged with the proximal end 104a of the spring 104 wherein the retaining collar portion 102b is secured about the area of threaded engagement.

FIGS. 2A-2C illustrate side and front views of a connector in addition to a threaded insert according to an embodiment of the invention. As shown, the connector 202 includes a sewer cable connection portion 202a and a retaining collar portion 202b. The sewer cable connection 202a is adapted to connect to a sewer cable and the retaining collar portion 202b functions to completely or substantially prevent the connector 200 from disengaging from a spring when connected thereto. A threaded insert 208 fits within a lumen of the connector 202 for threadedly engaging with a spring of a spring assembly.

FIGS. 3A-3B illustrate cross-sectional views of an assembled connector according to various embodiments. The connectors 302 (FIG. 3A) and 322 (FIG. 3B) may be adapted to receive different sewer cable connector portions. In one example, illustrated in FIG. 3A, the connector 302 includes a tapered portion 304, retaining collar portion 306, and a threaded insert 308. Additionally, the connector 302 may define a first cavity 310 within the tapered portion 304 and a second cavity 312 within the threaded insert 308, where the first and second cavities 310 and 312 are in communication with each other. The second cavity 312 may also include a threaded portion 314 within the second cavity 312. This allows a sewer cable connector to be coupled to the threaded portion 314 via the first cavity 310. Notably, different types of sewer cable connectors may be interchangeably couple to the connector 302 in this manner.

FIG. 3B illustrates another example of a connector 322 includes a tapered portion 324, retaining collar portion 326, and a threaded insert 328. Additionally, the connector 322 may define a first cavity 330 within the tapered portion 324 and a second cavity 332 within the threaded insert 328, where the first and second cavities 330 and 332 are in communication with each other. The first and second cavities 330 and 332 allow different sewer cable connectors to be coupled to the connector 322 by use of, for example, a screw passing from the second cavity 332 via the first cavity 330 to secure a sewer cable connector. Notably, different types of sewer cable connectors may be interchangeably couple to the connector 322 in this manner.

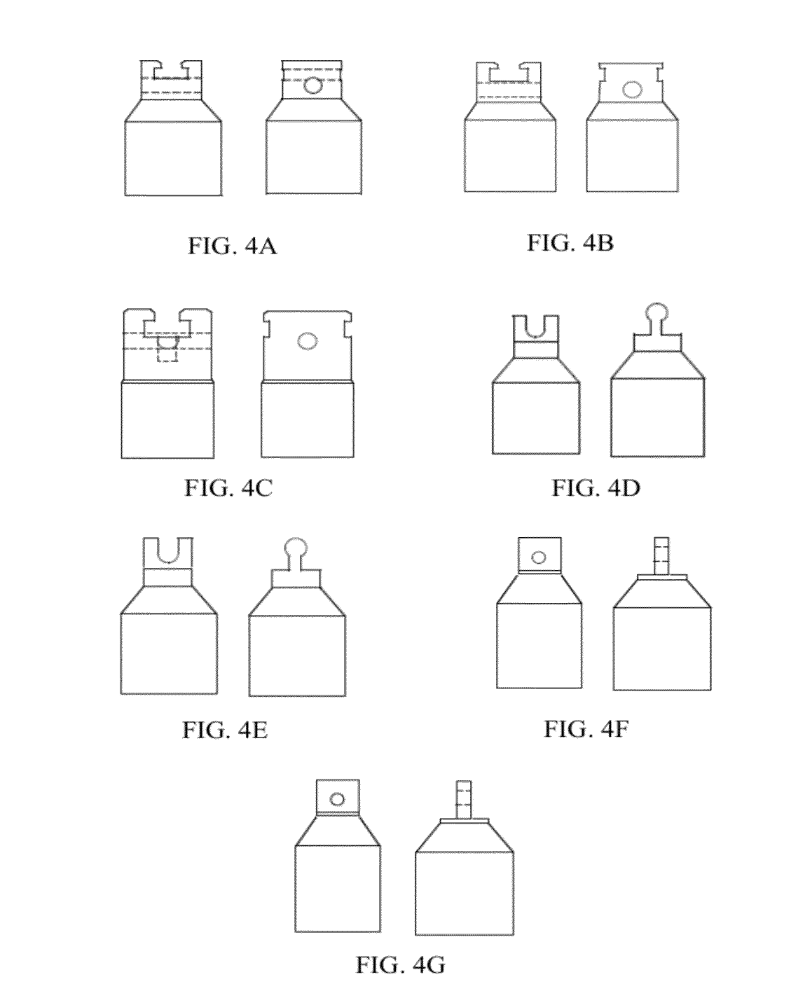

FIGS. 4A-4G illustrate front and side views of various connectors with various sewer cable connections portions according to various examples. In various embodiments, the sewer cable connections portions may be fixedly or removably coupled to a base connector, e.g., connectors 302 (FIG. 3A) and 322 (FIG. 3B). One of ordinary skill in the art will appreciate that the embodiments of connectors illustrated in FIGS. 4A-4G include sewer cable connections adapted to connect to standard sewer cables manufactured by different manufacturers within the industry. Other types of sewer cable connections may also be utilized.

FIGS. 5A-5C illustrate cross-sectional views of connectors according to alternative embodiments of the invention. FIG. 5A illustrates a first connector 502, e.g., connector 302 illustrated in FIG. 3A, having a threaded insert 504, a first cavity 506 and a threaded second cavity 508. This first connector 502 allows different sewer cable connections to be coupled by screwing them into the threaded second cavity 508 via the first cavity 506. FIG. 5B illustrates a second connector 510, e.g., connector 322 illustrated in FIG. 3B, having a threaded insert 512 and a cavity that extends through the insert 512 and remaining portions of the second connector 510. This second connector 510 allows different sewer cable connections to be coupled by passing a screw or fastener through the cavity. FIG. 5C illustrates a third connector 520 including an integral or removable sewer cable connector 522 and a threaded insert 524. According to these alternative embodiments, a retaining collar (528 in FIG. 5C) may be separate or integral with the connector and is used to keep a spring (526 in FIG. 5C) attached to a threaded insert. The retaining collar may be separately welded, screwed, threaded or crimped about the area of threaded engagement.

Note that the dimensions illustrated in FIGS. 5A, 5B, and 5C are by way of example only and other dimensions are possible. One of ordinary skill in the art will appreciate that the embodiments of connectors illustrated in FIGS. 5A-5C include sewer cable connections portions adapted to connect to standard sewer cables manufactured by different manufacturers within the industry.

FIG. 6 illustrates an embodiment of an end cap 602 which may be used to “cap-off” the spring assembly thereby housing the sonde within the spring assembly. The end cap 602 may include a semi-circular end 604 attached to a threaded insert 606. The threaded insert 606 may be adapted to receive and couple to the spring assembly. Note that the dimensions illustrated in FIG. 6 are by way of example only and other dimensions are possible.

FIG. 7 illustrates a schematic of a sewer cable attached to a spring assembly being used as a locator in a P-trap according to an embodiment of the invention. Similar to the spring assembly illustrated in FIGS. 1A-1D, the spring assembly 700 includes a connector 702 having a sewer cable connection portion 702a and a retaining collar portion 702b connected to a spring 704 to the spring 704 at an area in which the connector 702 attaches to the spring 704. A proximal end of the connector 702 may attach to a sewer cable 710. The sewer cable 710 may be, for example, from about eight (8) feet to about twenty-five (25) feet in length or more. The sewer cable 710 may be flexible and recoilable. Note that the spring 704 may include a medial portion in which the coils of the spring are spaced apart such that the spring 704 is sufficiently flexible to bend through a P-trap and elbows in a plumbing or sewer system. The flexibility of the medial portion of the spring allows pushing the sonde past the P-trap and further down the plumbing or sewer system to identify an obstruction or break in the plumbing or sewer system.

An end cap 706 may attach to a distal end of the spring 704 thereby creating a “housing” within a lumen or internal portion of the spring 704 in which a sonde 712 may be housed or carried therein. As used herein, a sonde 710 may include various devices for testing physical or environmental conditions. In one example, the sonde 710 can have a frequency range of between sixteen (16) Hertz (Hz) to thirty three (33) kHz, preferably about five hundred and twelve (512) Hz. The sonde 710 may be adapted to provide a signal that allows a receiver or detector to ascertain its location (and thereby obstruction) along a pipe. One of ordinary skill in the art will appreciate that the sonde 712 should be durable enough to withstand the harsh environment of plumbing and sufficiently small to be properly housed or carried within a spring. Similar to FIGS. 1A-1D, the connector 702, the spring 704, the end cap 706, and the sewer cable 710 may be manufactured using a suitable material, e.g., stainless steel.

In operation, a flexible auger, or push rod, with a spring assembly according to embodiments of the invention attached thereto may be introduced into a metallic or non-metallic plumbing or sewer system, e.g., clay, PVC or cast iron plumbing. The operator may use a locator, such as an analog locator, to detect the location of the sonde by detecting its frequency. As a result of precisely locating the sonde (with the analog locator), less digging is required by the operator to expose a blockage. Moreover, the sonde is easily recoverable as it is housed within the spring assembly which is substantially or completely unlikely to become disengaged from the connector due to the retaining collar portion. Thus, when torque is applied to the sewer cable, disengagement of the spring from the connector is substantially or completely reduced or eliminated. In one example, the spring assembly may be adapted to fit into pipes as small as one and one-half (1.5) inches and up to about eight (8) inches in diameter, and, due to the retaining collar portion, resists disengagement. Additionally, in comparison with prior art sondes which attach to the end of a push rod, the sonde according to embodiments of the invention is housed within the spring assembly thereby protecting it from the abrasiveness of cast iron pipes.

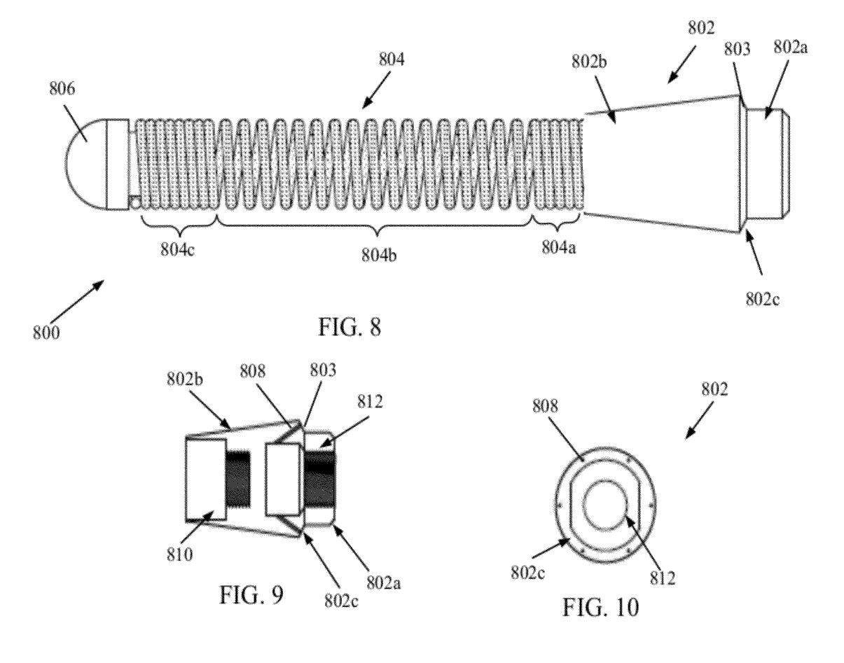

FIG. 8 illustrates a side view of a spring assembly according to an embodiment of the invention. A proximal end of the spring assembly 800 includes a nozzle 802 having a nozzle proximal end (or hydro-jet connector portion) 802a integrally connected to a nozzle distal end (or retaining collar portion) 802b via a nozzle medial portion (or propelling portion) 802c. Generally, the nozzle distal end 802b of the nozzle 802 attaches to a proximal end 804a of a spring 804 and the nozzle proximal end connects to a jetter hose (not shown). The spring 804 additionally includes a medial portion 804b and a distal end 804c. As shown, the proximal and distal ends 804a and 804c, respectively, of the spring 804 may be tightly wound coils, while the medial portion 804b of the spring 804 may be coils which are spaced a distance from one another or less tightly wound than the proximal and distal ends 804a and 804c. This feature provides flexibility to the spring 804. A distal end of the spring assembly 800 includes an end cap 806 attached to a distal end 804c of the spring 804.

According to one embodiment, the nozzle distal end 802b extends upwardly at an inclined angle to the nozzle medial portion 802c. The nozzle medial portion 802c extends downwardly, at an angle of 30 degrees or less, from the nozzle distal end 802b to the nozzle proximal end 802a. In one embodiment, the nozzle medial portion 802c may extend downwardly at an angle of 11 degrees. The nozzle medial portion 802c may include a plurality of jets 808. (See FIGS. 9 and 10) As shown, the plurality of jets 808 may include six (6) jets, however, this is by way of example only and the nozzle medial portion 802c may include more than six (6) jets or fewer than six (6). The jetter hose, attached to the nozzle proximal end 802a, delivers pulses of water under high pressure to the plurality of jets 808 in the nozzle 802 propelling the nozzle 802 along the sewer pipe.

FIG. 9 illustrates a cross-sectional view of the nozzle 802 in FIG. 8. As shown, the nozzle distal end 802b may include a first threaded portion 810 integral therein wherein the proximal end 804a of the spring 804 is adapted to receive the first threaded portion 810. Thus, the nozzle 802 attaches to the spring 804 by threaded engagement of the first threaded portion 810 to a threaded portion within the proximal end 804a of the spring 804. According to the embodiments described, the nozzle 802 is completely or substantially prevented from disengaging from the spring 804. More specifically, when torque or flex is applied to the spring assembly 800, the nozzle 802 substantially or completely prevents expansion of the tightly wound coils at the proximal end 804a of the spring 804. This, in turn, substantially or completely prevents the nozzle 802 from disengaging from the spring 804 when in use. As a result, the spring assembly 800 is permitted to pass through plumbing of various sizes.

The nozzle proximal end 802a includes a second threaded portion 812 integral therein wherein a jetter hose (not shown) is adapted to receive the second threaded portion 812. As described above, the jetter hose delivers pulses of water under high pressure to the plurality of jets 808 in the nozzle 802 propelling the nozzle 802 along the sewer pipe. According to one embodiment, each jet of the plurality of jets 808 may be located perpendicular to the outer surface 803 of the nozzle medial end 802c (See FIG. 9). A front elevational view of the nozzle 802 is shown in FIG. 10.

Similar to the nozzle 802, a proximal end of the end cap 806 may include threads therein, similar to the cap 602 in FIG. 6, wherein the distal end 804c of the spring 804 is adapted to receive the threads. Thus, the end cap 806 attaches to the distal end 804c of the spring 804 by threaded engagement thereto. According to one embodiment, a sonde (not shown, see FIG. 7) can be housed within the spring assembly 800, more specifically, within the spring 804. The nozzle 802, the spring 804, and the end cap 806 may be manufactured using a suitable material, e.g., stainless steel.

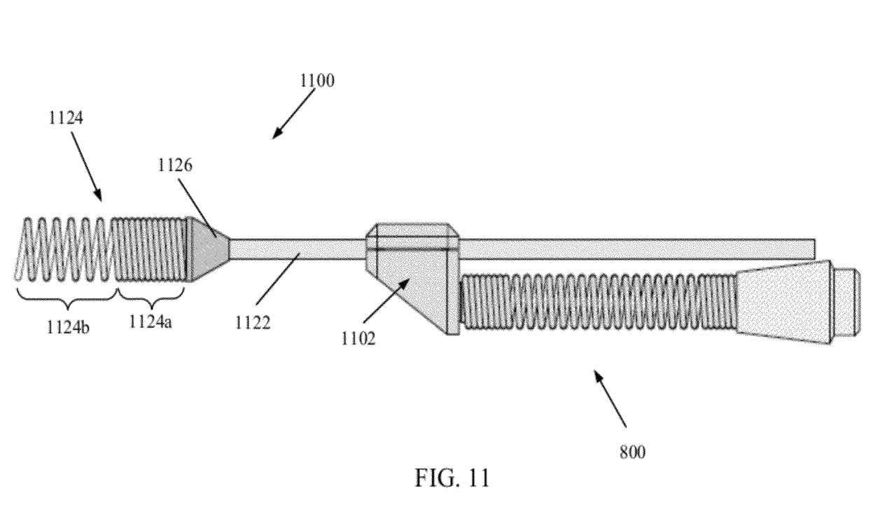

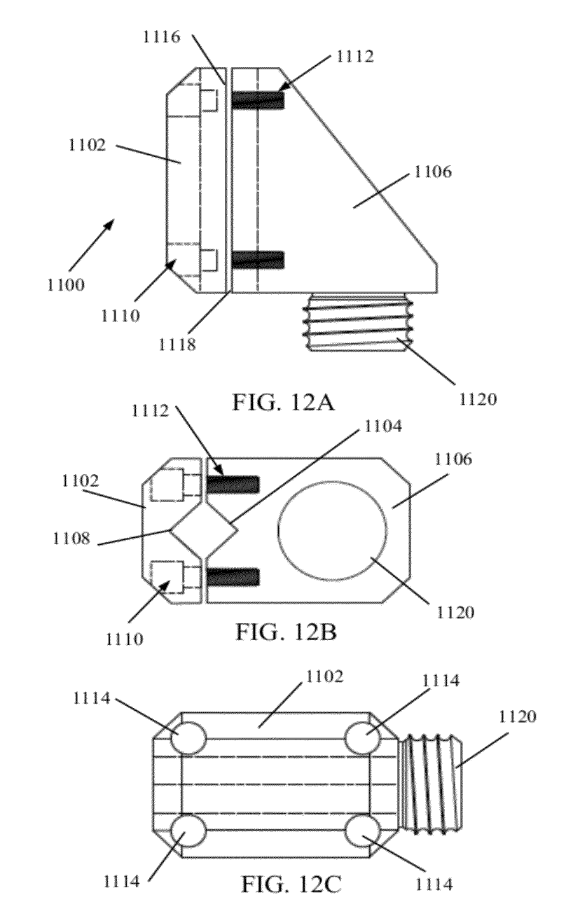

FIG. 11 illustrates a side view of the spring assembly 800 of FIG. 8 having a camera assembly 1100 attached with a clamp 1102. As shown in FIGS. 12A-C, in one embodiment, the clamp 1102 may include an upper clamp portion 1102 having a first channel 1104 extending the length of the upper clamp portion 1102 and a lower clamp portion 1106 having a second channel 1108 extending the length of the lower clamp portion 1108 (See FIG. 12B). The upper clamp portion 1102 may have a generally rectangular shape and the lower clamp potion 1106 may have a generally triangular shape.

A first plurality of holes 1110 may extend through the upper clamp portion 1102 and a second plurality of holes 1112, aligned with the first plurality of holes 1110 when the upper clamp portion 1102 is matingly engaged with the lower clamp portion 1106, may extend partially through the lower clamp portion 1106. A plurality of screws 1114 may extend through the aligned first and second plurality of holes 1110, 1112 and when tightened, a bottom surface 1116 of the upper clamp portion 1102 and an upper surface 1118 of lower clamp portion 1106 are drawn towards each other. The clamp 1102 may further include a threaded section 1120 for attaching to distal end 804c of the spring 804.

In one embodiment, the camera assembly 1100 may include an elongated rod 1122 attached to a spring 1224. The elongated rod 1122 may include a spring connector 1126 for attaching the spring 1124 to the elongated rod 1122. The spring 1124 may be fixedly secured to the spring connector 1126. Alternatively, the spring connector 1126 may include a threaded portion (not shown) integral therein wherein a proximal end 1124a of the spring 1124 is adapted to receive the threaded portion of the spring connector 1126. Thus, the spring connector 1126 attaches to the spring 1124 by threaded engagement of the threaded portion to a threaded portion within the proximal end 1124a of the spring 1124. According to the embodiments described, the spring connector 1126 is completely or substantially prevented from disengaging from the spring 1124. The spring 1124 additionally includes a distal end 1124b.

As shown, the proximal end 1124a of the spring 1124 may have tightly wound coils, while the distal end 1124b of the spring 1124 may have coils which are spaced a distance from one another or less tightly wound than the proximal end 1124a. This feature provides flexibility to the spring 1124a. A camera (not shown) may be attached to the distal end 1122b of the spring 1124 allowing for video inspect of the sewer pipe or other pipe into which the camera has been inserted.

To mount or attach the camera assembly 1100 to the spring assembly 800, the end cap 806 may be removed from the spring assembly 800 and the distal end 804c of the spring 804 is adapted to receive the threaded section 1120 of the clamp 1102. Thus, the threaded section 1120 of the clamp 1102 attaches to the distal end 804c of the spring 804 by threaded engagement thereto. Once the clamp 1102 has been attached to the spring 804, the elongated rod 1122 may be slid through an opening 1128 extending through the length of the clamp 1102. The opening 1128 may be created by the first channel 1104 and the second channel 1108 upon engagement of the upper clamp portion 1102 and the lower clamp portion 1106. Once the elongated rod 1122 has been inserted or placed within the opening 1128, the elongated rod 1122 may be positioned such that a camera (not shown) attached to the distal end 1122b of the spring 1124 is positioned in front of the spring assembly 800. The camera assembly 1100 provides for the video inspection of a pipe.

Once the elongated rod 1122 is in the proper position, as described above, the plurality of screws 1114 may be tightened causing the a bottom surface 1116 of the upper clamp portion 1102 and the upper surface 1118 of the lower clamp portion 1106 to be drawn towards each other securing the elongated rod 1122 with the clamp 1102.

In an alternative embodiment, the upper clamp portion 1102 may be separated (or unscrewed) from the lower clamp portion 1106 allowing the elongated rod to be placed within the first channel 1104. The upper clamp portion 1102 may then be aligned with and placed on top of the lower clamp portion 1106 so that the second channel 1108 is placed over the elongated rod 1122. The plurality of screws 1114 may then be extended through the aligned first and second plurality of holes 1110, 1112 and tightened causing the bottom surface 1116 of the upper clamp portion 1102 and the upper surface 1118 of lower clamp portion 1106 to be drawn towards each other securing the camera assembly 1100 within the clamp 1102.

According to one embodiment, the elongated rod nozzle 1122, the spring 1124, and the spring connector 1126 may be manufactured using a suitable material, e.g., stainless steel.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

1. A spring assembly, comprising:
a connector having a sewer cable connection portion at a proximal end and a retaining collar portion at a distal end;
a spring having a proximal end, a medial portion and a distal end, the proximal end of the spring connected to the distal end of the connector and retained by the retaining collar portion; and
a self-contained signal transmitter housed within the spring.

2. The spring assembly of claim 1, wherein the connector further comprises:
a threaded insert therein to receive the proximal end of the spring.

3. The spring assembly of claim 1, wherein the sewer cable connection portion is removably coupled to the connector to facilitate attaching different sewer cable connection portions.

4. The spring assembly of claim 1, wherein the connector includes a longitudinal cavity through which the sewer cable connection portion is secured to the connector.

5. The spring assembly of claim 1, further comprising:
an end cap threadedly engaged to the distal end of the spring.

6. The spring assembly of claim 1 wherein the proximal end and the distal end of the spring comprise tightly wound coils and the medial portion of the spring comprises coils spaced a distance from one another and wherein, when torque or flex is applied to the spring assembly, the retaining collar portion of the connector prevents expansion of the tightly wound coils at the proximal end of the spring.

7. The spring assembly of claim 1, further comprising:
a cable connected to the sewer cable connection portion of the connector.

8. The spring assembly of claim 1 wherein the self-contained signal transmitter is detectable by an external signal locator and adapted to transmit a wireless signal.

9. A spring assembly, comprising:
a nozzle having a nozzle proximal end integrally connected to a nozzle distal end via a nozzle medial portion, the nozzle medial portion includes a plurality of jets for receiving water under high pressure propelling the spring assembly down a pipe; and
a spring having a proximal end, a medial portion and a distal end, the proximal end of the spring connected to the nozzle distal end.

10. The spring assembly of claim 9, wherein the nozzle distal end extends upwardly at an inclined angle to the nozzle medial portion; and wherein the nozzle medial portion extends downwardly, at an angle of 30 degrees or less, from the nozzle distal end to the nozzle proximal end.

11. The spring assembly of claim 9, wherein each jet of the plurality of jets is located perpendicular to an outer surface of the nozzle medial end.

12. The spring assembly of claim 9, further comprising an end cap threadedly engaged to the distal end of the spring.

13. A device for locating an obstruction in a plumbing system, comprising:
a spring assembly, the spring assembly comprising:
a nozzle having a nozzle proximal end integrally connected to a nozzle distal end via a nozzle medial portion, the nozzle medial portion includes a plurality of jets for receiving water under high pressure propelling the spring assembly down a pipe; and
a first spring having a proximal end, a medial portion and a distal end, the proximal end of the spring connected to the nozzle distal end; and
a camera assembly secured to the spring assembly via a clamp, the clamp threadedly engaged to the distal end of the first spring.

14. The device of claim 13, wherein the camera assembly comprises
an elongated rod;
a second spring, having a second spring proximal end connected to a second spring distal end; and
a spring connector integrally connecting the second spring proximal end to the elongated rod.

15. The device of claim 14, wherein the clamp comprises:
an upper clamp portion having a first channel extending the length of the upper clamp portion; and
a lower clamp portion having a second channel extending the length of the lower clamp portion, the lower clamp portion secured to the upper clamp portion by a plurality of screws.

16. The device of claim 14, wherein the first channel and the second channel form an opening; and wherein the elongated rod is inserted into the opening for attaching the camera assembly to the clamp.

17. The device of claim 13, wherein the nozzle distal end extends upwardly at an inclined angle to the nozzle medial portion; and wherein the nozzle medial portion extends downwardly, at an angle of approximately 30 degrees, from the nozzle distal end to the nozzle proximal end.

18. The spring assembly of claim 13, wherein each jet of the plurality of jets is located perpendicular to an outer surface of the nozzle medial end.

19. (canceled)

20. (canceled)
